(19) United States
(12) Patent Application Publication
(10) Pub. No.: US 2025/0119878 A1
(43) Pub. Date: Apr. 10, 2025

(54) RESOURCE PROCESSING METHOD AND APPARATUS, AND TERMINAL

(71) Applicant: VIVO MOBILE COMMUNICATION CO., LTD., Dongguan (CN)

(72) Inventors: Can LI, Dongguan (CN); Huan WANG, Dongguan (CN); Zichao JI, Dongguan (CN)

(73) Assignee: VIVO MOBILE COMMUNICATION CO., LTD., Dongguan (CN)

(21) Appl. No.: 18/983,228

(22) Filed: Dec. 16, 2024

Related U.S. Application Data
(63) Continuation of application No. PCT/CN2023/098941, filed on Jun. 7, 2023.

(30) Foreign Application Priority Data
Jun. 14, 2022 (CN) 202210675038.3

(51) Int. Cl. H04W 72/02; H04B 17/318; H04W 28/26; H04W 72/0446; H04W 72/25

(52) U.S. Cl. CPC H04W 72/02; H04B 17/328; H04W 28/26; H04W 72/0446; H04W 72/25

(57) ABSTRACT

This application provides a resource processing method and apparatus, and a terminal. The resource processing method includes: a terminal acquires a first candidate resource set; the terminal selects A second candidate resources from the first candidate resource set to form a second candidate resource set; and the terminal selects a target resource for transmission and/or reservation from the second candidate resource set. The first candidate resource set includes at least one first candidate resource. One second candidate resource occupies n slots, n is an integer greater than or equal to 1 and less than or equal to N. A is a positive integer. N is an integer greater than 1, and the n slots are consecutive in time domain.

### CROSS-REFERENCE TO RELATED APPLICATIONS

This application is a continuation of International Application No. PCT/CN 2023/098941, filed on Jun. 7, 2023, which claims priority to Chinese Patent Application No. 202210675038.3 filed on Jun. 14, 2022. The entire contents of each of the above-referenced applications are expressly incorporated herein by reference.

### TECHNICAL FIELD

This application relates to the field of communication technologies, and in particular, to a resource processing method and apparatus, and a terminal.

### BACKGROUND

Sidelink (SL, or translated as a side link, or the like) transmission means that data is directly transmitted between User Equipment (UE) on a physical layer. A Long Term Evolution (LTE) sidelink is based on broadcast communication and may be used for supporting basic security communication for Vehicle to Everything (V2X), but is not suitable for more advanced V2X services. A 5G New Radio (NR) system supports more advanced sidelink transmission designs, such as unicast, multicast or groupcast, thereby supporting more comprehensive service types.

NR SL supports chained resource reservation. For example, Sidelink Control Information (SCI) indicates that, in addition to a current transmission resource, at most two resources may be additionally reserved. The SCI may further indicate at most three reserved resources in a next resource periodicity. In a selection window, resources may be persistently reserved by using a dynamic reservation mode.

Because acquiring a channel through channel listen before talk (listen before talk, LBT) on an unlicensed spectrum may fail, transmission cannot be performed on reserved SL resources. After LBT succeeds, transmission can only be performed in a current slot. For next transmission in a reserved inconsecutive slot, LBT needs to be performed again, reducing the SL transmission efficiency and spectrum efficiency.

### SUMMARY

Embodiments of this application provide a resource processing method and apparatus, and a terminal, to improve sidelink transmission efficiency.

According to a first aspect, a resource processing method is provided. The method includes:
A terminal acquires a first candidate resource set, where the first candidate resource set includes at least one first candidate resource;
the terminal selects A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and
the terminal selects a target resource for transmission and/or reservation from the second candidate resource set.

According to a second aspect, a resource processing apparatus is provided. The apparatus is used in a terminal and includes:
an acquisition module, configured to acquire a first candidate resource set, where the first candidate resource set includes at least one first candidate resource;
a selection module, configured to select A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and
a processing module, configured to select a target resource for transmission and/or reservation from the second candidate resource set.

According to a third aspect, a terminal is provided. The terminal includes a processor and a memory. The memory stores a program or instructions executable on the processor, and when the program or the instructions are executed by the processor, the steps of the method according to the first aspect are implemented.

According to a fourth aspect, a terminal is provided. The terminal includes a processor and a communication interface, where the communication interface is configured to acquire a first candidate resource set, and the first candidate resource set includes at least one first candidate resource. The processor is configured to: select A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and select a target resource for transmission and/or reservation from the second candidate resource set.

According to a fifth aspect, a readable storage medium is provided. The readable storage medium stores a program or instructions, and when the program or the instructions are executed by a processor, the steps of the method according to the first aspect are implemented.

According to a sixth aspect, a chip is provided. The chip includes a processor and a communication interface, where the communication interface is coupled to the processor, and the processor is configured to run a program or instructions to implement the method according to the first aspect.

According to a seventh aspect, a computer program/program product is provided. The computer program/program product is stored in a storage medium, and the computer program/program product is executed by at least one processor to implement the steps of the resource processing method according to the first aspect.

In embodiments of this application, the target resource for transmission and/or reservation is selected from the second candidate resource set. The second candidate resources occupy n consecutive slots in time domain. In this case, the target resource for transmission and/or reservation also occupies the n consecutive slots in time domain. When n is greater than 1, once LBT is successful, a plurality of slots may be transmitted consecutively without performing LBT again in a next slot, thereby improving sidelink transmission efficiency and time frequency resource efficiency.

### BRIEF DESCRIPTION OF THE DRAWINGS

FIG. 1 is a block diagram of a wireless communication system to which an embodiment of this application may be applied;

FIG. 2 is a schematic diagram in which frequency domain resource limitation of a PSCCH is less than or equal to a size of one subchannel, and the PSCCH is located within a range of a lowest subchannel of the PSSCH;

FIG. 3 is a schematic flowchart of a resource processing method according to an embodiment of this application;

FIG. 4 is a schematic diagram in which a candidate resource is reported by a physical layer according to an embodiment of this application;

FIG. 5 is a schematic diagram of a time-domain consecutive resource according to an embodiment of this application;

FIG. 6 is a schematic diagram in which a multi-slot resource is reported by a physical layer according to an embodiment of this application;

FIG. 7 is a schematic diagram of a structure of a resource processing apparatus according to an embodiment of this application;

FIG. 8 is a schematic diagram of a structure of a communication device according to an embodiment of this application; and

FIG. 9 is a schematic diagram of a structure of a terminal according to an embodiment of this application.

### DETAILED DESCRIPTION

The technical solutions in embodiments of this application are clearly described below with reference to the accompanying drawings in embodiments of this application. Apparently, the described embodiments are merely some rather than all of embodiments of this application. All other embodiments obtained by a person of ordinary skill in the art based on embodiments of this application fall within the protection scope of this application.

In the specification and claims of this application, the terms “first”, “second”, and the like are used to distinguish similar objects, but are not used to describe a specific sequence or order. It should be understood that the terms used in such a way are interchangeable in a proper case, so that embodiments of this application can be implemented in an order different from the order shown or described herein. In addition, the objects distinguished by “first” and “second” are usually of a same type, without limiting a quantity of objects. For example, there may be one or more first objects. In addition, “and/or” in the specification and the claims means at least one of the connected objects, and the character “/” generally indicates an “or” relationship between the associated objects.

It should be noted that the technology described in embodiments of this application is not limited to a Long Term Evolution (LTE)/LTE-Advanced (LTE-A) system, and may further be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and another system. The terms “system” and “network” in embodiments of this application are often used interchangeably, and the described technologies may be used both for the systems and radio technologies mentioned above as well as to other systems and radio technologies. The following descriptions describe a New Radio (NR) system for illustrative purposes, and NR terms are used in most of the descriptions below. However, these technologies is also applied to applications other than NR system applications, such as a 6th Generation (6G) communication system.

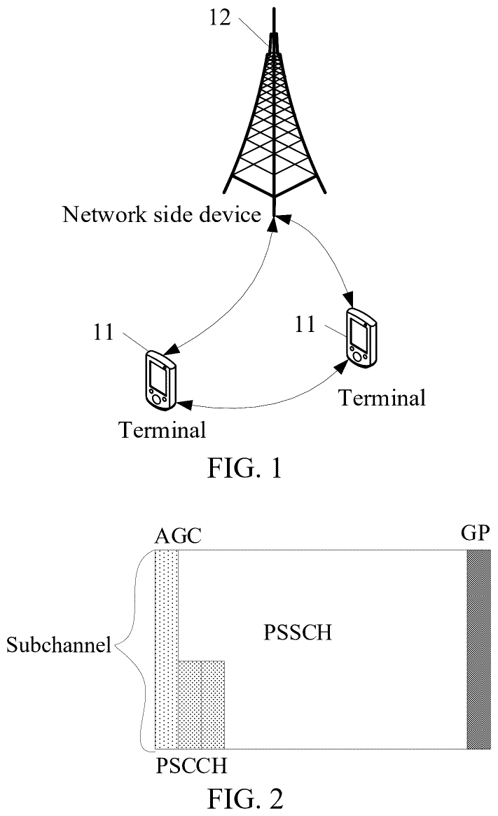

FIG. 1 is a block diagram of a wireless communication system to which an embodiment of this application may be applied. The wireless communication system includes a terminal 11 and a network side device 12. The terminal 11 may be a terminal side device, such as a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart appliance (a home appliance with a wireless communication function, for example, a refrigerator, a television, a washing machine, or furniture), a game console, a personal computer (PC), a teller machine, or a self-service machine. The wearable device includes: a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that, a specific type of the terminal 11 is not limited in embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) Access Point (AP), a Wireless Fidelity (Wi-Fi) node, or the like. The base station may be referred to as a Node B (NB), an Evolved Node B (eNB), an access point, a Base Transceiver Station (BTS), a radio base station, a radio transceiver, a Basic Service Set (BSS), an Extended Service Set (ESS), a Home Node B (HNB), a home evolved Node B, a Transmitting Receiving Point (TRP), or another appropriate term in the art. The base station is not limited to a specific technical term, provided that a same technical effect is achieved. It should be noted that in embodiments of this application, a base station in an NR system is merely used as an example, and a specific type of the base station is not limited.

An NR sidelink includes the following channels:
a Physical Sidelink Control Channel (PSCCH);
a Physical Sidelink Shared Channel (PSSCH);
a Physical Sidelink Broadcast Channel (PSBCH); and
a Physical Sidelink Feedback Channel (PSFCH).

The PSSCH allocates resources in units of subchannels and uses a consecutive resource allocation mode in frequency domain. A time domain resource of the PSCCH is a quantity of symbols configured by a higher layer. A size of frequency domain is a parameter set by the higher layer. Frequency domain resource limitation of the PSCCH is less than or equal to a size of one subchannel, and the PSCCH is located within a range of a lowest subchannel of the PSSCH, as shown in FIG. 2.

SL UE includes two resource allocation modes: a mode 1 and a mode 2. In the mode 1, a base station schedules a resource. In the mode 2, the UE determines which resource to use for transmission. Resource information may be a broadcast message or preconfigured information from the base station. When the UE operates within a range of the base station and has a Radio Resource Control (RRC) connection with the base station, the UE may operate in the mode 1 and/or the mode 2. When the UE operates within the range of the base station without an RRC connection with the base station, the UE only operates in the mode 2. When the UE operates outside the range of the base station, the UE only operates in the mode 2 and performs SL transmission based on the preconfigured information.

For the mode 2, a specific operation mode is as follows: (1) After a resource selection is triggered, transmit end (TX) UE first determines a resource selection window. A lower boundary of the resource selection window is at T1 after the resource selection is triggered, and an upper boundary of the resource selection window is at T2 after the trigger, where T2 is a value selected by the UE within a Packet Delay Budget (PDB) transmitted by a Transport Block (TB), and T2 is not earlier than T1. (2) Before the resource selection, the UE needs to determine a candidate resource set for the resource selection, and compare Reference Signal Received Power (RSRP) measured on a resource in the resource selection window with a corresponding RSRP threshold, if the RSRP is lower than an RSRP threshold, the resource may be included in a candidate resource set. (3) After the resource set is determined, the UE randomly selects a transmission resource from the candidate resource set. In addition, during this transmission, the UE may reserve a transmission resource for subsequent transmission.

NR SL supports a chained resource reservation mode. For example, Sidelink Control Information (SCI) indicates that, in addition to a current transmission resource, at most two resources may be additionally reserved. The SCI may further indicate at most three reserved resources in a next resource periodicity. In a selection window, resources may be persistently reserved by using a dynamic reservation mode.

The higher layer requires the UE to determine a resource subset during re-evaluation/preemption check, and the higher layer provides sets for re-evaluation/preemption check respectively. The UE may determine whether to report the re-evaluation/preemption check to the higher layer through the resource selection.

For the re-evaluation, if a candidate resource set is determined through resource selection and a resource in a re-evaluation set provided by the higher layer is not in the candidate resource set, the UE reports the re-evaluation of the resource to the higher layer.

For the preemption check, if the candidate resource set is determined through resource selection and a resource in a preemption check set provided by the higher layer is not in the candidate resource set, the resource does not satisfy an RSRP sensing condition, a priority indicated by corresponding SCI meets a requirement, and a preselected resource is not included in the candidate set, the re-evaluation is triggered.

For a sidelink on an unlicensed spectrum (SL-U), a channel needs to be acquired through channel Listen Before Talk (LBT) before SL data is sent. The following provides a brief introduction to an LBT technology.

In a future communication system, a shared spectrum such as an unlicensed band may be used as supplement to a licensed band to assist an operator in expanding a service. To be consistent with NR deployment and optimize NR-based unlicensed access, the unlicensed band may operate in a 5 GHz, a 37 GHz, and a 60 GHz band. The unlicensed bands are shared in various technologies (RATs), such as Wi-Fi, radar, LTE-LAA, and the like. Accordingly, in some countries or regions, the unlicensed band need to comply with regulation during use, to ensure that all devices may fairly use the resource, such as LBT, MCOT (maximum channel occupancy time, maximum channel occupancy time), and another regulation. When a transmission node needs to send information, LBT needs to be performed first, and Energy Detection (ED) is performed on surrounding nodes. When detected energy is lower than a threshold, a channel is considered to be idle, and the transmission node can send the information. When detected power is not lower than a threshold, a channel is considered to be busy, and the transmission node cannot send the information. The transmission node may be a base station, UE, Wi-Fi AP, or the like. After the transmission node starts transmitting, occupancy channel time COT cannot exceed MCOT. In addition, according to an Occupied Channel Bandwidth (OCB) regulation, in the unlicensed band, the transmission node occupies at least 70% (60 GHz) or 80% (5 GHz) of the entire band during each transmission.

Types of LBT commonly used in NRU may be divided into a Type 1, a Type 2A, a Type 2B, and a Type 2C. Type 1 LBT is a back-off-based channel listening mechanism. When the transmission node listens that the channel is busy, back-off is performed and the listening is continued until the transmission node listens that the channel is idle. For the Type 2C, a sending node does not perform LBT, that is, no LBT or immediate transmission exists. Type 2A and Type 2B LBT belong to one-shot LBT. In other words, a node performs one LBT before transmission. If the channel is idle, the transmission is performed, and if the channel is busy, the transmission is not performed. A difference is that the Type 2A performs LBT within 25 us, which is suitable for sharing the COT when a gap between two transmission is greater than or equal to 25 us. The Type 2B performs LBT within 16 us, which is suitable for sharing the COT when a gap between two transmission is equal to 16 us. In addition, Type 2 LBT is suitable for License Assisted Access (LAA)/Enhanced Licensed Assisted Access (eLAA)/FeLAA. A gap between two transmission is greater than or equal to 25 us when the COT is shared. Both eNB and UE can use the Type 2 LBT. In addition, in a frequency range 2-2, types of LBT include a Type 1, a Type 2, and a Type 3. The Type 1 is a back-off-based channel listening mechanism. The Type 2 is one-shot LBT, and performs LBT for 5 us within 8 us. The Type 3 does not perform LBT.

To increase utilization of a time frequency resources after LBT is successful, a sidelink may support a multi-slot-based resource. Once LBT is successful, a plurality of slots may be transmitted consecutively.

The following describes a resource processing method provided in embodiments of this application in detail by using some embodiments and application scenarios thereof with reference to the accompanying drawings.

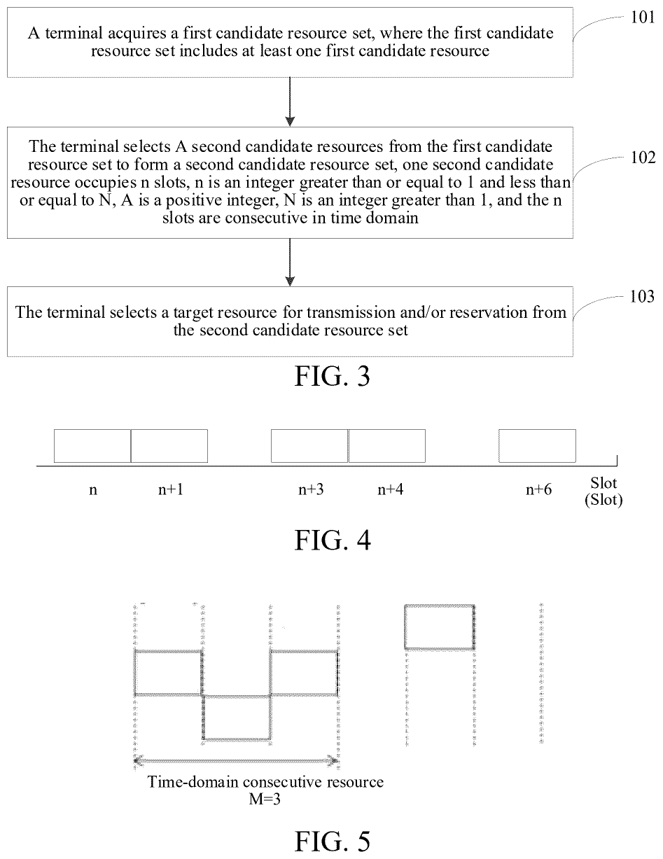

An embodiment of this application provides a resource processing method. As shown in FIG. 3, the method includes:

Step 101: A terminal acquires a first candidate resource set, where the first candidate resource set includes at least one first candidate resource.

Step 102: The terminal selects A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain.

Step 103: The terminal selects a target resource for transmission and/or reservation from the second candidate resource set.

In embodiments of this application, the target resource for transmission and/or reservation is selected from the second candidate resource set. The second candidate resources occupy n consecutive slots in time domain. In this case, the target resource for transmission and/or reservation also occupies the n consecutive slots in time domain. When n is greater than 1, once LBT is successful, a plurality of slots may be transmitted consecutively without performing LBT again in a next slot, thereby improving sidelink transmission efficiency and time frequency resource efficiency.

In the second candidate resource set, different second candidate resources may occupy different quantities of slots. A value of n, representing a quantity of slots occupied by second candidate resources is selected from the range of 1 to N, and the value of n may be 1, 2, . . . , N−1, or N. For example, different second candidate resources in the second candidate resource set may occupy a same quantity of slots.

In some embodiments, in the second candidate resource set, the A second candidate resources may be arranged from small to large according to an index of the slots. The target resource may be N1 second candidate resources with a smallest slot index in the second candidate resource set, where N1 is a positive integer.

For example, a first protocol layer may randomly select the A1 second candidate resources from the A second candidate resources. A value of A1 may be predefined by a protocol or configured by a higher layer parameter.

N1 may be a minimum value of A and Q, and Q is a quantity of reserved second candidate resources configured by a higher layer of the terminal. The higher layer includes a Medium Access Control (MAC) layer and a Radio Link Control (RLC) layer. For example, the MAC layer may randomly select or select one second candidate resource with the smallest index as the target resource, where Q=1.

For example, a second protocol layer may further indicate a reserved resource periodicity to another terminal through SCI, and the target resource needs to be reserved in each reserved resource periodicity, so that the terminal may reserve a plurality of resources once, thereby enabling to send a periodic services of the terminal.

In some embodiments, the second protocol layer may further indicate, through the SCI, a quantity of slots occupied by the target resource to another terminal.

In some embodiments, the selecting, by the terminal, A second candidate resources from the first candidate resource set to form a second candidate resource set includes:
A second protocol layer of the terminal reports the first candidate resource set to a first protocol layer; and
the first protocol layer selects the A second candidate resources from the first candidate resource set to form the second candidate resource set.

The first protocol layer may be a higher layer of the terminal, such as the MAC layer, and the second protocol layer may be a physical layer of the terminal. After the first protocol layer sends the second candidate resource set to the second protocol layer, the second protocol layer selects the target resource for transmission and/or reservation from the second candidate resource set, and sends the target resource to another terminal through the SCI.

In some embodiments, one first candidate resource occupies one slot or occupies i consecutive slots in time domain, and i is an integer greater than 1 and less than or equal to N. In other words, the first candidate resource may occupy one slot or the i consecutive slots in time domain, and a value of i is an integer greater than 1 and less than or equal to N.

In a specific embodiment, the first candidate resource occupies one slot in time domain. The terminal measures reference signal received power RSRP of the first candidate resource and reports a measurement result to the first protocol layer. The first protocol layer selects one or more second candidate resources from the first candidate resource set. Each second candidate resource occupies n consecutive slots in time domain. When n is greater than 1, n consecutive first candidate resources in time domain form the second candidate resource. In a specific example, as shown in FIG. 4, the second protocol layer reports first candidate resources of a slot k, a slot k+1, a slot k+3, a slot k+4, and a slot k+6 to the first protocol layer. The first protocol layer determines n=2 based on a channel measurement result reported by the second protocol layer, and selects {slot k, slot k+1} and {slot k+3, slot k+4} that meet a time-domain consecutive resource requirement as the second candidate resource set. In other words, the second candidate resource set includes two second candidate resources, a 1^{st} second candidate resource occupies the slot k and the slot k+1, and a 2^{nd} second candidate resource occupies the slot k+3 and the slot k+4. Then, the second protocol layer may indicate to another terminal through SCI that {slot k, slot k+1} is a transmission resource. For a plurality of first candidate resources, frequency domain resources in different slots are the same, or frequency domain resources in different slots are different, or frequency domain resources in different slots are distributed based on a preset pattern.

In some embodiments, one first candidate resource occupies i consecutive slots in time domain, referred to as a multi-slot resource. In other words, a resource occupies a plurality of consecutive slots in time domain. The first protocol layer selects or preferentially selects a first candidate resource that meets a time-domain consecutiveness requirement as the second candidate resource. The time-domain consecutiveness requirement includes: The first candidate resource occupies M consecutive slots in time domain, or a combination of the first candidate resource and another first candidate resource occupies M consecutive slots in time domain, where M is an integer greater than or equal to i.

For example, when M is equal to i, each first candidate resource meets the time-domain consecutiveness requirement. When M is greater than i (for example, i=2, M=4), if a first candidate resource 1 occupies the slot k and the slot k+1 in time domain, and a first candidate resource 2 occupies the slot k+2 and the slot k+3 in time domain, it is determined that the first candidate resource 1 and the first candidate resource 2 meet the time-domain consecutiveness requirement, because a combination of the first candidate resource 1 and the first candidate resource 2 occupies the M consecutive slots in time domain. M is a value agreed upon in a protocol, configured or preconfigured by a network side device, independently determined by the terminal, or negotiated between the terminal and a peer terminal.

A quantity of first candidate resources reported by the second protocol layer may be configured by a higher layer or independently determined by the terminal.

When the resources reported by the second protocol layer are a multi-slot candidate resource set, the first protocol layer may select one or more multi-slot candidate resources as the second candidate resource. In some embodiments, the first protocol layer preferentially selects a multi-slot candidate resource that meets the time-domain consecutiveness requirement as the second candidate resource. If a quantity of the multi-slot candidate resources that meet the time-domain consecutiveness requirement is insufficient, another multi-slot candidate resource is selected as the second candidate resource.

In some embodiments, one first candidate resource occupies the i consecutive slots in time domain. The consecutive i slots are included in a first time-domain consecutive resource, the first time-domain consecutive resource includes M consecutive slot resources, and M is an integer greater than or equal to i. For example, the first candidate resource reported by the second protocol layer needs to be included in the first time-domain consecutive resource. For example, when M=6, the time-domain consecutive resource occupies the slot k, the slot k+1, a slot k+2, the slot k+3, the slot k+4, and a slot k+5 in time domain, the first candidate resource reported by the second protocol layer needs to be included in the slot k to the slot k+5. For example, when i=2, the first candidate resource reported by the second protocol layer reports may occupy the slot k and the slot k+1 in time domain, or the first candidate resource reported by the second protocol layer may occupy the slot k+2 and the slot k+3 in time domain.

When the multi-slot candidate resource reported by the second protocol layer is included in the first time-domain consecutive resource, the first protocol layer selects the multi-slot candidate resource that meets the time-domain consecutiveness requirement as the second candidate resource.

In this embodiment, the first time-domain consecutive resource includes resources that are consecutive in time domain, and may include multi-slot candidate resources that are consecutive in time domain, or may include multi-slot candidate resources that are consecutive and do not overlap in time domain, or may include single-slot candidate resources that are consecutive in time domain. In a specific example, as shown in FIG. 5, the first time-domain consecutive resource M=3 and includes three single-slot candidate resources that are consecutive and do not overlap in time domain.

In embodiments of this application, the second protocol layer may report the first candidate resource that occupies 1 slot or occupies the i consecutive slots in time domain, and the first protocol layer determines, based on the first candidate resource, the second candidate resource that occupies the n slots in time domain. In some embodiments, the second protocol layer may directly report the first candidate resource that occupies the n slots in time domain.

When the second protocol layer directly reports the first candidate resource occupying the n slots in time domain, that a second protocol layer reports the first candidate resource set to a first protocol layer includes:
determining at least one fourth candidate resource in a resource selection window, where one fourth candidate resource occupies n consecutive slots, where in the fourth candidate resource, each slot occupies a same frequency domain resources, or frequency domain resources in different slots are distributed based on a preset pattern; n is a value agreed upon in a protocol, configured or preconfigured by the network side device, independently determined by the terminal (for example, determined by the MAC layer), or negotiated between the terminal and a peer terminal; for example, n may be 1, n may be 2, n may be 4, or the like; when n is greater than 1, the fourth candidate resource is a multi-slot candidate resource; and when n=1, the fourth candidate resource is a single-slot candidate resource;
excluding a fifth resource from the at least one fourth candidate resource to obtain at least one sixth candidate resource, where the fifth resource includes at least one of the following: an eighth resource, a ninth resource, or a resource including a physical sidelink feedback channel; and
determining the at least one sixth candidate resource as the first candidate resource set in a case that the at least one sixth candidate resource satisfies a first condition; or in a case that the at least one sixth candidate resource does not satisfy the first condition, adjusting a preset first RSRP threshold, and repeating the step of excluding the fifth resource from the fourth candidate resource, where
the first condition includes at least one of the following:
in the first candidate resource set, a proportion of the sixth candidate resource in the fourth candidate resource is greater than or equal to a first preset value;
a ratio of a quantity of second time-domain consecutive resources in the first candidate resource set to a total quantity of resources in the resource selection window is greater than a second preset value; or
a quantity of second time-domain consecutive resources in the first candidate resource set is greater than a third preset value, where
the first preset value, the second preset value, or the third preset value is a value agreed upon in a protocol, configured or preconfigured by a network side device, independently determined by the terminal (for example, determined by the MAC layer), or negotiated between the terminal and the peer terminal. The first condition is set, so that it is ensured that there are sufficient first candidate resources in the first candidate resource set.

The second time-domain consecutive resource includes sixth candidate resources that are consecutive in time domain, or the second time-domain consecutive resource includes sixth candidate resources that are consecutive and do not overlap in time domain.

The eighth resource satisfies the following condition: For a first slot in which SCI is not detected in a sensing window, all slots reserved for the first slot overlap with a slot reserved for the eighth resource in the resource selection window, and exclusion of the eighth resource means exclusion of a non-monitored slot-based candidate resource. For example, for slots that are not monitored in a sensing window, namely, slots in which SCI is not received, assuming that the SCI is received in the slots and that all slots that are possibly (periodically) reserved in the selection window are included, the terminal excludes the candidate resources where these slots are located.

For example, if a resource potentially (periodically) reserved in a non-monitored slot is included in the multi-slot candidate resource, the multi-slot candidate resources is excluded. In some embodiments, if the resource that is potentially (periodically) reserved in the non-monitored slot and that is included in the multi-slot candidate resource is greater than a preset value/preset proportion, the multi-slot candidate resource is excluded. For example, a quantity of slots of resources potentially (periodically) reserved in the non-monitored slot may be n, or 1, or any value in a range of 1 to n, depending on protocol configuration and terminal implementation. In some embodiments, a quantity of slots is set to 1 to retain as many consecutive resources in time domain as possible.

The ninth resource satisfies the following condition:

For a slot in which first SCI is detected in the sensing window, all slots reserved in the resource selection window as indicated by the first SCI overlap with the ninth resource and/or a corresponding reserved resource, a reference value of RSRP of a target channel corresponding to the first SCI is greater than the first RSRP threshold, and the target channel is a PSCCH or PSSCH for carrying the first SCI. Exclusion of the ninth resource means exclusion of a sensing based candidate resource. For example, RSRP measurement is performed on the PSCCH or PSSCH indicated by the SCI received in the sensing window. The RSRP measurement value can reflect the RSRP value of the resource reserved for the SCI. If the RSRP reference value of a multi-slot candidate resource is greater than the RSRP threshold, the multi-slot candidate resource is excluded, where the RSRP reference value is calculated from the RSRP measurement value.

Further, to exclude the candidate resource, the following condition needs to be satisfied: any slot and/or a preset slot and/or all slots in the candidate resource overlap with the resource in the selection window indicated by the SCI received by the sensing window.

The reference value of the RSRP is any one of the following:
an average value of RSRP of n slots of the ninth resource;
an equivalent value of RSRP of n slots of the ninth resource;
a maximum value of RSRP of n slots of the ninth resource;
a minimum value of RSRP of n slots of the ninth resource;
a preset partial value of RSRP of n slots of the ninth resource; or
RSRP of any one of n slots of the ninth resource.

The first RSRP threshold may be determined by a priority of the physical sidelink shared channel PSSCH and/or a priority of the physical sidelink control channel PSCCH indicated by the SCI.

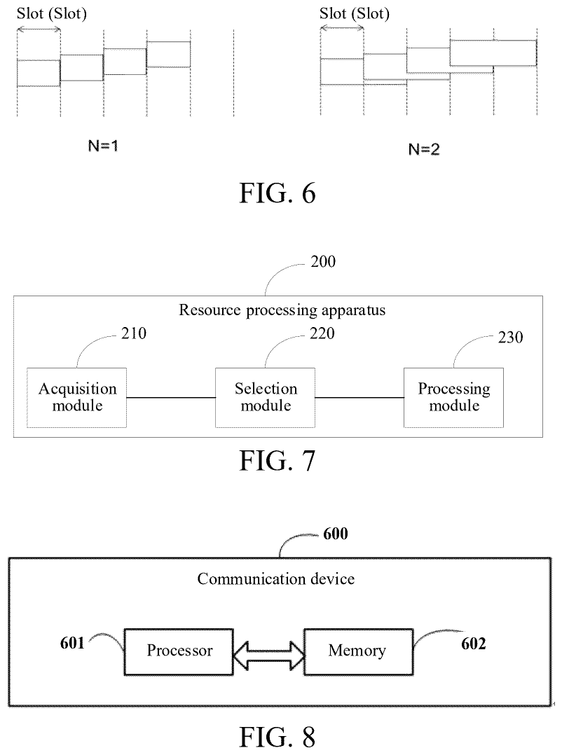

In a specific example, as shown in FIG. 6, the physical layer reports a multi-slot resource. For example, if the resource selection window has a total of S slots, N consecutive slots starting from a first slot form one multi-slot candidate resource, while N consecutive slots starting from a second slot are another multi-slot candidate resource. (in some embodiments, N consecutive slots starting from a first slot form one multi-slot candidate resource, while N consecutive slots starting from an (N+1)^{th} slot are another multi-slot candidate resource.)

The candidate resource may be excluded based on the non-monitored slot. For example, for slots that are not monitored in the sensing window, namely, slots in which SCI is not received, assuming that the SCI is received in the slots and that all slots that are possibly (periodically) reserved in the selection window are included, UE excludes the candidate resources where these slots are located. Exclusion of the sensing based candidate resource is as follows: For example, RSRP measurement is performed on the PSCCH or PSSCH indicated by the SCI received in the sensing window. The RSRP measurement value can reflect the RSRP value of the resource reserved for the SCI. If the RSRP value of a multi-slot candidate resource is greater than the RSRP threshold, the multi-slot candidate resource is excluded. After resource exclusion, if a proportion of a remaining multi-slot candidate resource in the multi-slot candidate resource set is greater than the preset value, the resource exclusion is completed.

In some embodiments, the time length of the fourth candidate resource is not greater than the length of the channel occupancy time of the terminal, thereby avoiding reporting an invalid fourth candidate resource and increasing workload of resource exclusion.

In some embodiments, a time domain position of the fourth candidate resource is determined by a candidate resource of a PSFCH. For example, a time domain unit of the fourth candidate resource is a period of the PSFCH, or starts at a next slot of a PSFCH occasion, or ends at the PSFCH occasion slot, thereby avoiding inconsecutive candidate resources due to the PSFCH and ensuring consecutiveness of the candidate resources.

In some embodiments, determining the fourth candidate resource includes:
determining a seventh candidate resource in the resource selection window, where the seventh candidate resource occupies one slot; and selecting n seventh candidate resources that are consecutive in time domain to form one fourth candidate resource.

For example, when n=3, a seventh candidate resource occupying the slot k, a seventh candidate resource occupying the slot k+1, and a seventh candidate resource occupying the slot k+2 may form a fourth candidate resource. In some embodiments, when n=4, a seventh candidate resource occupying the slot k, a seventh candidate resource occupying the slot k+1, a seventh candidate resource occupying the slot k+2, and a seventh candidate resource occupying the slot k+3 may form a fourth candidate resource.

In some embodiments, the method further includes:

The first protocol layer receives a resource evaluation detection result of a first resource reported by the second protocol layer; and excludes the first resource from the second candidate resource set, where the first resource belongs to a first set used for resource evaluation detection and satisfies at least one of the following: A resource corresponding to a first slot of the first resource does not overlap with a resource of any element in the first candidate resource set; or the first resource is not an element in the first candidate resource set.

The resource evaluation detection includes resource preemption detection and/or resource re-evaluation, and the resource evaluation detection result includes a resource preemption detection result and/or a resource re-evaluation result. In this way, the terminal is prevented from selecting a resource that may be preempted or re-evaluated as the target resource.

In some embodiments, the first resource further satisfies the following condition: The reference signal received power RSRP of the SCI corresponding to the first resource is greater than a preset second RSRP threshold, the first resource and/or a time frequency resource of the second resource reserved for the SCI at least partially overlap with the first candidate resource and/or the time frequency resource of the reserved resource corresponding to the first candidate resource, and a layer 1 priority indicated by the SCI is lower than a layer 1 priority of data currently sent by the terminal, and/or the layer 1 priority indicated by the SCI is higher than a preset layer 1 priority.

In some embodiments, a moment for triggering the second protocol layer to perform resource evaluation detection includes at least one of the following:
a first moment, where the first moment is earlier than a seventh moment, duration between the first moment and the seventh moment is T3, and the seventh moment is a starting moment of a first slot of a fourth candidate resource with a smallest slot index;
a second moment, where the second moment is earlier than an eighth moment, duration between the second moment and the eighth moment is T3, and the eighth moment is a starting moment of a first slot of the second time-domain consecutive resource; or
a third moment, where the third moment is earlier than a ninth moment, duration between the third moment and the ninth moment is T3, and the ninth moment is a starting moment of a first slot of channel occupancy time, where
T3 is a preset value. Triggering the second protocol layer to perform resource evaluation and detection at the first moment, the second moment, or the third moment may speed up the resource evaluation and detection, thereby enabling the terminal to find a suitable resource more quickly.

In some embodiments, the moment for triggering the second protocol layer to perform the resource evaluation detection further includes at least one of the following:
a fourth moment, where the fourth moment is earlier than a tenth moment, duration between the fourth moment and the tenth moment is T3, and the tenth moment is a starting moment of a slot of the fourth candidate resource other than the first slot of the fourth candidate resource;
a fifth moment, where the fifth moment is earlier than an eleventh moment, duration between the fifth moment and the eleventh moment is T3, and the eleventh moment is a starting moment of a slot of the second time-domain consecutive resource other than the first slot of the second time-domain consecutive resource; or
a sixth moment, where the sixth moment is earlier than a twelfth moment, duration between the sixth moment and the twelfth moment is T3, and the twelfth moment is a starting moment of a slot of the channel occupancy time other than the first slot of the channel occupancy time.

Triggering the second protocol layer to perform resource evaluation and detection at the fourth moment, the fifth moment, or the sixth moment can obtain a more flexible resource evaluation and detection occasion, thereby increasing the terminal to have more opportunities to find a suitable resource.

Further, the first slot may be replaced by “a slot other than the first slot” or “any slot”.

In some embodiments, a third condition for the second protocol layer to report the resource evaluation detection result to the first protocol layer includes at least one of the following:
For the resource evaluation detection triggered at the first moment, the second moment, or the third moment, RSRP of SCI corresponding to the first resource is greater than a preset second RSRP threshold; or
for the resource evaluation detection triggered at the fourth moment, the fifth moment, or the sixth moment, RSRP of SCI corresponding to the first resource is greater than a preset third RSRP threshold, and a preset offset exists between the third RSRP threshold and the second RSRP threshold. In this way, suitable resources in various situations may be adjusted, thereby ensuring found resources to be more suitable for the terminal.

In some embodiments, after the second protocol layer performs the resource evaluation detection, the method further includes:

The terminal skips resource reselection in a case that a new candidate resource set does not include a candidate resource that is in a same slot as the excluded first resource, to ensure temporal consecutiveness of transmission resources; or in a case that a new candidate resource set includes a candidate resource that is in a same slot as the excluded first resource, the terminal selects or preferentially selects the candidate resource, to ensure temporal consecutiveness of transmission resources.

In some embodiments, the second protocol layer sends, in a case that a second condition is satisfied, SCI to another terminal to indicate to release a reserved resource, to improve resource utilization. The second condition includes at least one of the following:
A length of obtained channel occupancy time is less than a length of n slots;
a resource required for to-be-transmitted data of the terminal is less than n slots; or
a length of a slot for retransmission is less than a length of n slots.

In some embodiments, N is configured by an RRC layer, determined by the first protocol layer, or determined by the second protocol layer.

N configured by the RRC layer is determined based on at least one of the following:
a maximum number of retransmissions allowed;
a maximum quantity of slots for consecutive transmission;
a layer 1 priority of a transmission with the terminal;
a resource pool for the terminal;
a channel access priority class; or
a PC5 5th Generation (5G) Quality of Service (QOS) Indicator (PQI) of to-be-transmitted data of the terminal.

N determined by the first protocol layer is determined based on at least one of the following:
a higher-layer parameter indication, for example, the higher layer parameter indicates that N is less than or equal to the number of retransmissions, or less than or equal to a quantity of consecutive slots, in this case, N may not be a single value;
information reported by the second protocol layer, for example, N is determined based on information such as RSRP, a Modulation and Coding Scheme (MCS), and Channel Quality Indicator (CQI);
a length of channel occupancy time corresponding to a channel access priority class, for example, the N slots are required to be less than or equal to a length of COT length; or
a first candidate resource reported by the second protocol layer, for example, based on a quantity of candidate resources, a length or quantity of consecutive candidate resources, and the like, N is determined and N resources are selected.

N determined by the second protocol layer is determined based on at least one of the following:
a channel measurement result, for example, the physical layer detects, based on the channel measurement result (RSRP, MCS, and CQI), a reservation result, and the like, that a resource of a channel with a length of N is optimal, and reports a corresponding candidate set of resources with a time domain unit of N, N<=Z, and Z is a positive integer specified by the MAC layer or configured by the network side device through RRC;
a length of channel occupancy time corresponding to a channel access priority class, N is determined based on the length of the COT corresponding to the LBT priority class, for example, the N slots are less than or equal to the length of the COT; or
a higher-layer parameter indication, for example, the higher layer parameter indicates that N is less than or equal to the number of retransmissions, or less than or equal to the quantity of consecutive slots, in this case, N may not be a single value.

An execution entity of the resource processing method provided in embodiments of this application may be a resource processing apparatus. In this embodiment of this application, the resource processing apparatus provided in embodiments of this application is described by using an example in which the resource processing apparatus performs the resource processing method.

An embodiment of this application provides a resource processing apparatus used in a terminal. As shown in FIG. 7, the resource processing apparatus 200 includes:
an acquisition module 210, configured to acquire a first candidate resource set, where the first candidate resource set includes at least one first candidate resource;
a selection module 220, configured to select A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and
a processing module 230, configured to select a target resource for transmission and/or reservation from the second candidate resource set.

In embodiments of this application, the target resource for transmission and/or reservation is selected from the second candidate resource set. The second candidate resources occupy n consecutive slots in time domain. In this case, the target resource for transmission and/or reservation also occupies the n consecutive slots in time domain. When n is greater than 1, and LBT is successful in the first slot of the target resource, there is no need to perform LBT again in a next slot, thereby improving sidelink transmission efficiency and spectrum efficiency.

In some embodiments, the selecting, by the terminal, A second candidate resources from the first candidate resource set to form a second candidate resource set includes:
A second protocol layer of the terminal reports the first candidate resource set to a first protocol layer; and
the first protocol layer selects the A second candidate resources from the first candidate resource set to form the second candidate resource set.

In some embodiments, one first candidate resource occupies one slot or occupies i consecutive slots in time domain, and i is an integer greater than 1 and less than or equal to N.

In some embodiments, one first candidate resource occupies i consecutive slots in time domain, the first protocol layer selects or preferentially selects a first candidate resource that meets a time-domain consecutiveness requirement as the second candidate resource, and the time-domain consecutiveness requirement includes: The first candidate resource occupies M consecutive slots in time domain, or a combination of the first candidate resource and another first candidate resource occupies M consecutive slots in time domain, where M is an integer greater than or equal to i.

In some embodiments, one first candidate resource occupies the i consecutive slots in time domain. The consecutive i slots are included in a first time-domain consecutive resource, the first time-domain consecutive resource includes M consecutive slot resources, and M is an integer greater than or equal to i.

In some embodiments, the second protocol layer indicates a quantity of slots occupied by the target resource through sidelink control information SCI.

In some embodiments, that a second protocol layer reports the first candidate resource set to a first protocol layer includes:
determining at least one fourth candidate resource in a resource selection window, where one fourth candidate resource occupies n consecutive slots;
excluding a fifth resource from the at least one fourth candidate resource to obtain at least one sixth candidate resource, where the fifth resource includes at least one of the following: an eighth resource, a ninth resource, or a resource including a physical sidelink feedback channel; and
determining the at least one sixth candidate resource as the first candidate resource set in a case that the at least one sixth candidate resource satisfies a first condition; or in a case that the at least one sixth candidate resource does not satisfy a first condition, adjusting a preset first reference signal received power RSRP threshold, and repeating the step of excluding the fifth resource from the fourth candidate resource, where
the first condition includes at least one of the following:
in the first candidate resource set, a proportion of the sixth candidate resource in the fourth candidate resource is greater than or equal to a first preset value;
a ratio of a quantity of second time-domain consecutive resources in the first candidate resource set to a total quantity of resources in the resource selection window is greater than a second preset value; or
a quantity of second time-domain consecutive resources in the first candidate resource set is greater than a third preset value, where
the second time-domain consecutive resource includes sixth candidate resources that are consecutive in time domain, or the second time-domain consecutive resource includes sixth candidate resources that are consecutive and do not overlap in time domain;
the eighth resource satisfies the following condition: for a first slot in which SCI is not detected in a sensing window, all slots reserved for the first slot overlap with a slot reserved for the eighth resource in the resource selection window; and
the ninth resource satisfies the following condition:
for a slot in which first SCI is detected in the sensing window, all slots reserved in the resource selection window as indicated by the first SCI overlap with the ninth resource and/or a corresponding reserved resource, a reference value of RSRP of a target channel corresponding to the first SCI is greater than the first RSRP threshold, and the target channel is a PSCCH or PSSCH for carrying the first SCI.

In some embodiments, in the fourth candidate resource, each slot occupies a same frequency domain resource, or frequency domain resources in different slots are distributed based on a preset pattern.

In some embodiments, the reference value of the RSRP is any one of the following:
an average value of RSRP of n slots of the ninth resource;
an equivalent value of RSRP of n slots of the ninth resource;
a maximum value of RSRP of n slots of the ninth resource;
a minimum value of RSRP of n slots of the ninth resource;
a preset partial value of RSRP of n slots of the ninth resource; or
RSRP of any one of n slots of the ninth resource.

In some embodiments, the first RSRP threshold is determined by a priority of the physical sidelink shared channel PSSCH and/or a priority of the physical sidelink control channel PSCCH indicated by SCI.

In some embodiments, a time length of the fourth candidate resource is not greater than a length of channel occupancy time of the terminal.

In some embodiments, a time domain position of the fourth candidate resource is determined by a candidate resource of a PSFCH.

In some embodiments, the processing module 230 is configured to determine a seventh candidate resource in the resource selection window, where the seventh candidate resource occupies one slot; and select n seventh candidate resources that are consecutive in time domain to form one fourth candidate resource.

In some embodiments, the first protocol layer receives a resource evaluation detection result of a first resource reported by the second protocol layer; and excludes the first resource from the second candidate resource set, where the first resource belongs to a first set used for resource evaluation detection and satisfies at least one of the following: A resource corresponding to a first slot of the first resource does not overlap with a resource of any element in the first candidate resource set; or the first resource is not an element in the first candidate resource set.

In some embodiments, a moment for triggering the second protocol layer to perform resource evaluation detection includes at least one of the following:
a first moment, where the first moment is earlier than a seventh moment, duration between the first moment and the seventh moment is T3, and the seventh moment is a starting moment of a first slot of a fourth candidate resource with a smallest slot index;
a second moment, where the second moment is earlier than an eighth moment, duration between the second moment and the eighth moment is T3, and the eighth moment is a starting moment of a first slot of the second time-domain consecutive resource; or
a third moment, where the third moment is earlier than a ninth moment, duration between the third moment and the ninth moment is T3, and the ninth moment is a starting moment of a first slot of channel occupancy time, where
T3 is a preset value.

In some embodiments, the moment for triggering the second protocol layer to perform the resource evaluation detection further includes at least one of the following:
a fourth moment, where the fourth moment is earlier than a tenth moment, duration between the fourth moment and the tenth moment is T3, and the tenth moment is a starting moment of a slot of the fourth candidate resource other than the first slot of the fourth candidate resource;
a fifth moment, where the fifth moment is earlier than an eleventh moment, duration between the fifth moment and the eleventh moment is T3, and the eleventh moment is a starting moment of a slot of the second time-domain consecutive resource other than the first slot of the second time-domain consecutive resource; or
a sixth moment, where the sixth moment is earlier than a twelfth moment, duration between the sixth moment and the twelfth moment is T3, and the twelfth moment is a starting moment of a slot of the channel occupancy time other than the first slot of the channel occupancy time.

In some embodiments, a third condition for the second protocol layer to report the resource evaluation detection result to the first protocol layer includes at least one of the following:
for the resource evaluation detection triggered at the first moment, the second moment, or the third moment, RSRP of SCI corresponding to the first resource is greater than a preset second RSRP threshold; or
for the resource evaluation detection triggered at the fourth moment, the fifth moment, or the sixth moment, RSRP of SCI corresponding to the first resource is greater than a preset third RSRP threshold, and a preset offset exists between the third RSRP threshold and the second RSRP threshold.

In some embodiments, after the second protocol layer performs the resource evaluation detection, the terminal skips resource reselection in a case that a new candidate resource set does not include a candidate resource that is in a same slot as the excluded first resource; or in a case that a new candidate resource set includes a candidate resource that is in a same slot as the excluded first resource, the terminal selects or preferentially selects the candidate resource.

In some embodiments, the second protocol layer sends, in a case that the second condition is satisfied, SCI to another terminal to indicate to release a reserved resource, where the second condition includes at least one of the following:
a length of obtained channel occupancy time is less than a length of n slots;
a resource required for to-be-transmitted data of the terminal is less than n slots; or
a length of a slot for retransmission is less than a length of n slots.

In some embodiments, N is configured by an RRC layer, determined by the first protocol layer, or determined by the second protocol layer.

N configured by the RRC layer is determined based on at least one of the following:
a maximum number of retransmissions allowed;
a maximum quantity of slots for consecutive transmission;
a layer 1 priority of a transmission with the terminal;
a resource pool for the terminal;
a channel access priority class; or
a PC5 5th Generation (5G) Quality of Service (QOS) Indicator (PQI) of to-be-transmitted data of the terminal.

N determined by the first protocol layer is determined based on at least one of the following:
a higher-layer parameter indication;
information reported by the second protocol layer;
a length of channel occupancy time corresponding to a channel access priority class; or
a first candidate resource reported by the second protocol layer,
N determined by the second protocol layer is determined based on at least one of the following:
a channel measurement result;
a length of channel occupancy time corresponding to a channel access priority class; or
a higher-layer parameter indication.

The resource processing apparatus in embodiments of this application may be an electronic device, for example, an electronic device having an operating system, or may be a component in the electronic device, for example, an integrated circuit or a chip. The electronic device may be a terminal, or may be a device other than the terminal. For example, the terminal may include but is not limited to a type of the terminal 11 listed above, and another device may be a server, a Network Attached Storage (NAS), or the like. This is not specifically limited in this embodiment of this application.

The resource processing apparatus according to this embodiment of this application can implement processes implemented in the method embodiments shown in FIG. 3 to FIG. 6. To avoid repetition, details are not described herein again.

For example, as shown in FIG. 8, an embodiment of this application further provides a communication device 600, including a processor 601 and a memory 602. The memory 602 stores a program or instructions executable on the processor 601. For example, when the communication device 600 is a terminal, and the program or the instructions are executed by the processor 601, the steps in the foregoing resource processing method embodiments are implemented, and a same technical effect is achieved. To avoid repetition, details are not described herein again.

An embodiment of this application further provides a terminal. The terminal includes a processor and a memory. The memory stores a program or instructions executable on the processor. When the program or the instructions are executed by the processor, the steps of the foregoing resource processing method are implemented.

An embodiment of this application further provides a terminal, including a processor and a communication interface. The communication interface is configured to acquire a first candidate resource set, where the first candidate resource set includes at least one first candidate resource. The processor is configured to: select A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and select a target resource for transmission and/or reservation from the second candidate resource set.

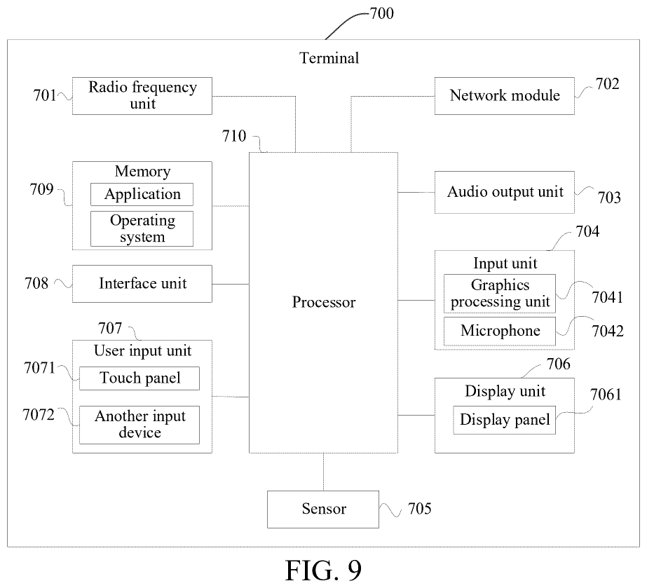

An embodiment of this application further provides a terminal, including a processor and a communication interface. The terminal embodiment corresponds to the foregoing terminal side method embodiment. Implementation processes and implementations of the foregoing method embodiments may all be applied to the terminal embodiment, and a same technical effect can be achieved. For example, FIG. 9 is a schematic diagram of a hardware structure of a terminal according to an embodiment of this application.

The terminal 700 includes, but is not limited to, at least some of the following components, such as a radio frequency unit 701, a network module 702, an audio output unit 703, an input unit 704, a sensor 705, a display unit 706, a user input unit 707, an interface unit 708, a memory 709, and a processor 710.

The terminal 700 may further include power supply (such as a battery) for supplying power to the components. The power supply may be logically connected to the processor 710 by using a power management system, thereby implementing functions such as charging, discharging, and power consumption management by using the power management system. The terminal structure shown in FIG. 9 does not constitute a limitation on the terminal, and the terminal may include more or fewer components than those shown in the figure, or some components are combined, or component arrangements are different. Details are not described herein.

It should be understood that, in embodiments of this application, the input unit 704 may include a Graphics Processing Unit (GPU) 7041 and a microphone 7042. The graphics processing unit 7041 performs processing on image data of a static picture or a video that is obtained by an image capture apparatus (for example, a camera) in a video capture mode or an image acquisition mode. The display unit 706 may include a display panel 7061. The display panel 7061 may be configured in the form of a liquid crystal display, an organic light-emitting diode, or the like. The user input unit 707 includes at least one of a touch panel 7071 and another input device 7072. The touch panel 7071 is referred to as a touch screen. The touch panel 7071 may include two parts: a touch detection apparatus and a touch controller. The another input device 7072 may include, but is not limited to, a physical keyboard, a functional key (such as a volume control key or a switch key), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes, but is not limited to, an antenna, an amplifier, a transceiver, a coupler, a low noise amplifier, a duplexer, and the like.

The memory 709 is configured to store a software program or instructions and various data. The memory 709 may mainly include a first storage area for storing the program or the instructions and a second storage area for storing the data. The first storage area may store an operating system, an application or instructions (such as an audio play function and an image play function) required by at least one function, and the like. In addition, the memory 709 may include a volatile memory or a non-volatile memory, or may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DRRAM). The memory 709 described in this embodiment of this application includes, but is not limited to, these memories and any other suitable types of memories.

The processor 710 may include one or more processing units. For example, the processor 710 may integrate an application processor and a modem processor. The application processor mainly processes an operating system, a user interface, an application program, and the like, and the modem processor such as a baseband processor mainly processes a wireless communication signal. It should be understood that, in some embodiments, the modem processor may not be integrated into the processor 710.

In some embodiments, the processor 710 is configured to acquire a first candidate resource set, where the first candidate resource set includes at least one first candidate resource; select A second candidate resources from the first candidate resource set to form a second candidate resource set, where one second candidate resource occupies n slots, n is an integer greater than or equal to 1 and less than or equal to N, A is a positive integer, N is an integer greater than 1, and the n slots are consecutive in time domain; and select a target resource for transmission and/or reservation from the second candidate resource set.

In some embodiments, a second protocol layer of the terminal reports the first candidate resource set to a first protocol layer; and
the first protocol layer selects the A second candidate resources from the first candidate resource set to form the second candidate resource set.

In some embodiments, one first candidate resource occupies one slot or occupies i consecutive slots in time domain, and i is an integer greater than 1 and less than or equal to N.

In some embodiments, one first candidate resource occupies i consecutive slots in time domain, the first protocol layer selects or preferentially selects a first candidate resource that meets a time-domain consecutiveness requirement as the second candidate resource, and the time-domain consecutiveness requirement includes: The first candidate resource occupies M consecutive slots in time domain, or a combination of the first candidate resource and another first candidate resource occupies M consecutive slots in time domain, where M is an integer greater than or equal to i.

In some embodiments, one first candidate resource occupies the i consecutive slots in time domain. The consecutive i slots are included in a first time-domain consecutive resource, the first time-domain consecutive resource includes M consecutive slot resources, and M is an integer greater than or equal to i.

In some embodiments, the processor 710 indicates a value of n through sidelink control information SCI.

In some embodiments, the processor 710 is configured to determine at least one fourth candidate resource in a resource selection window, where one fourth candidate resource occupies n consecutive slots; excluding a fifth resource from the at least one fourth candidate resource to obtain at least one sixth candidate resource, where the fifth resource includes at least one of the following: an eighth resource, a ninth resource, or a resource including a physical sidelink feedback channel; and determining the at least one sixth candidate resource as the first candidate resource set in a case that the at least one sixth candidate resource satisfies a first condition; or in a case that the at least one sixth candidate resource does not satisfy a first condition, adjusting a preset first reference signal received power RSRP threshold, and repeating the step of excluding the fifth resource from the fourth candidate resource, where
the first condition includes at least one of the following:
in the first candidate resource set, a proportion of the sixth candidate resource in the fourth candidate resource is greater than or equal to a first preset value;
a ratio of a quantity of second time-domain consecutive resources in the first candidate resource set to a total quantity of resources in the resource selection window is greater than a second preset value; or
a quantity of second time-domain consecutive resources in the first candidate resource set is greater than a third preset value, where
the second time-domain consecutive resource includes sixth candidate resources that are consecutive in time domain, or the second time-domain consecutive resource includes sixth candidate resources that are consecutive and do not overlap in time domain;
the eighth resource satisfies the following condition: for a first slot in which SCI is not detected in a sensing window, all slots reserved for the first slot overlap with a slot reserved for the eighth resource in the resource selection window; and
the ninth resource satisfies the following condition:
for a slot in which first SCI is detected in the sensing window, all slots reserved in the resource selection window as indicated by the first SCI overlap with the ninth resource and/or a corresponding reserved resource, a reference value of RSRP of a target channel corresponding to the first SCI is greater than the first RSRP threshold, and the target channel is a PSCCH or PSSCH for carrying the first SCI.

In some embodiments, in the fourth candidate resource, each slot occupies a same frequency domain resource, or frequency domain resources in different slots are distributed based on a preset pattern.

In some embodiments, the reference value of the RSRP is any one of the following:
an average value of RSRP of n slots of the ninth resource;
an equivalent value of RSRP of n slots of the ninth resource;
a maximum value of RSRP of n slots of the ninth resource;
a minimum value of RSRP of n slots of the ninth resource;
a preset partial value of RSRP of n slots of the ninth resource; or
RSRP of any one of n slots of the ninth resource.

In some embodiments, the first RSRP threshold is determined by a priority of the physical sidelink shared channel PSSCH and/or a priority of the physical sidelink control channel PSCCH indicated by SCI.

In some embodiments, a time length of the fourth candidate resource is not greater than a length of channel occupancy time of the terminal.

In some embodiments, a time domain position of the fourth candidate resource is determined by a candidate resource of a PSFCH.

In some embodiments, the processor 710 is configured to determine seventh candidate resources in the resource selection window, where the seventh candidate resource occupies one slot; and select n seventh candidate resources that are consecutive in time domain to form one fourth candidate resource.

In some embodiments, the processor 710 is configured to receive a resource evaluation detection result of a first resource reported by the second protocol layer; and exclude the first resource from the second candidate resource set, where the first resource belongs to a first set used for resource evaluation detection and satisfies at least one of the following: A resource corresponding to a first slot of the first resource does not overlap with a resource of any element in the first candidate resource set; or the first resource is not an element in the first candidate resource set.

In some embodiments, a moment for triggering the second protocol layer to perform resource evaluation detection includes at least one of the following:
a first moment, where the first moment is earlier than a seventh moment, duration between the first moment and the seventh moment is T3, and the seventh moment is a starting moment of a first slot of a fourth candidate resource with a smallest slot index;
a second moment, where the second moment is earlier than an eighth moment, duration between the second moment and the eighth moment is T3, and the eighth moment is a starting moment of a first slot of the second time-domain consecutive resource; or
a third moment, where the third moment is earlier than a ninth moment, duration between the third moment and the ninth moment is T3, and the ninth moment is a starting moment of a first slot of channel occupancy time, where
T3 is a preset value.

In some embodiments, the moment for triggering the second protocol layer to perform the resource evaluation detection further includes at least one of the following:
a fourth moment, where the fourth moment is earlier than a tenth moment, duration between the fourth moment and the tenth moment is T3, and the tenth moment is a starting moment of a slot of the fourth candidate resource other than the first slot of the fourth candidate resource;
a fifth moment, where the fifth moment is earlier than an eleventh moment, duration between the fifth moment and the eleventh moment is T3, and the eleventh moment is a starting moment of a slot of the second time-domain consecutive resource other than the first slot of the second time-domain consecutive resource; or
a sixth moment, where the sixth moment is earlier than a twelfth moment, duration between the sixth moment and the twelfth moment is T3, and the twelfth moment is a starting moment of a slot of the channel occupancy time other than the first slot of the channel occupancy time.

In some embodiments, a third condition for the second protocol layer to report the resource evaluation detection result to the first protocol layer includes at least one of the following:
for the resource evaluation detection triggered at the first moment, the second moment, or the third moment, RSRP of SCI corresponding to the first resource is greater than a preset second RSRP threshold; or
for the resource evaluation detection triggered at the fourth moment, the fifth moment, or the sixth moment, RSRP of SCI corresponding to the first resource is greater than a preset third RSRP threshold, and a preset offset exists between the third RSRP threshold and the second RSRP threshold.

In some embodiments, after the second protocol layer performs the resource evaluation detection, the terminal skips resource reselection in a case that a new candidate resource set does not include a candidate resource that is in a same slot as the excluded first resource; or in a case that a new candidate resource set includes a candidate resource that is in a same slot as the excluded first resource, the terminal selects or preferentially selects the candidate resource.

In some embodiments, the processor 710 is configured to send, in a case that a second condition is satisfied, SCI to another terminal to indicate to release a reserved resource, where the second condition includes at least one of the following:
a length of obtained channel occupancy time is less than a length of n slots;
a resource required for to-be-transmitted data of the terminal is less than n slots; or
a length of a slot for retransmission is less than a length of n slots.

In some embodiments, N is configured by an RRC layer, determined by the first protocol layer, or determined by the second protocol layer.

N configured by the RRC layer is determined based on at least one of the following:
a maximum number of retransmissions allowed;
a maximum quantity of slots for consecutive transmission;
a layer 1 priority of a transmission with the terminal;
a resource pool for the terminal;
a channel access priority class; or
a PC5 5th generation (5G) quality of service (QOS) indicator (PQI) of to-be-transmitted data of the terminal.

N determined by the first protocol layer is determined based on at least one of the following:
a higher-layer parameter indication;
information reported by the second protocol layer;
a length of channel occupancy time corresponding to a channel access priority class; or
a first candidate resource reported by the second protocol layer,

N determined by the second protocol layer is determined based on at least one of the following:
a channel measurement result;
a length of channel occupancy time corresponding to a channel access priority class; or
a higher-layer parameter indication.

An embodiment of this application further provides a readable storage medium. The readable storage medium stores a program or instructions. When the program or the instructions are executed by a processor, processes in the foregoing resource processing method embodiments are implemented and a same technical effect is achieved. To avoid repetition, details are not described herein again.

The processor is the processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip, including a processor and a communication interface. The communication interface is coupled to the processor. The processor is configured to run a program or instructions to implement processes in the foregoing resource processing method embodiments and achieve a same technical effect. To avoid repetition, details are not described herein again.

It should be understood that the chip mentioned in this embodiment of this application may also be referred to as a system-on-chip, a system chip, a chip system, a system-on-a-chip, or the like.

An embodiment of this application further provides a computer program/a program product, stored in a storage medium. The computer program/the program product is executed by at least one processor to implement processes in the foregoing resource processing method embodiments and achieve a same technical effect. To avoid repetition, details are not described herein again.

It should be noted that, the terms “include”, “comprise” or any other variants thereof in this application are intended to cover non-exclusive inclusion, so that a process, method, article or apparatus that includes a series of elements includes not only those elements, but also other elements that are not explicitly listed or elements inherent to the process, method, article, or apparatus. Without more limitations, elements defined by the sentence “including one” does not exclude that there are still other same elements in the processes, methods, objects, or apparatuses. In addition, it should be noted that the method and apparatus in embodiments of this application is not limited to performing functions in the order shown or discussed, but performing functions in a substantially simultaneous manner or in reverse order, depending on the functions, also falls within the scope thereof. For example, the described method may be performed in an order different from that described, and various steps may be added, omitted, or combined. In addition, features described in some examples may be combined in other examples.

According to the descriptions in the foregoing embodiments, a person skilled in the art can clearly learn that the method according to the foregoing embodiment may be implemented by relying on software and a necessary general hardware platform, and may be implemented by hardware, but in many cases, the former relates to better implementations. Based on such an understanding, the technical solutions of this application essentially, or the part contributing to the conventional technologies, may be presented in the form of a computer software product. The computer software product is stored in a storage medium (for example, a ROM/RAM, a magnetic disk, or an optical disc) including a plurality of instructions to enable a terminal (which may be a mobile phone, a computer, a server, an air conditioner, a network device, or the like) to perform the method according to embodiments of this application.

Embodiments of this application have been described above with reference to the accompanying drawings. This application is not limited to the specific embodiments above, and the specific embodiments above are merely examples and not limitative. Those of ordinary skill in the art may make various variations under the teaching of this application without departing from the spirit of this application and the protection scope of the claims, and such variations shall all fall within the protection scope of this application.

What is claimed is:

1. A resource processing method, comprising:
acquiring, by a terminal, a first candidate resource set, wherein the first candidate resource set comprises at least one first candidate resource;
selecting, by the terminal, A second candidate resources from the first candidate resource set to form a second candidate resource set, wherein one second candidate resource occupies n slots, n is an integer greater than or equal to 1 and less than or equal to N, A is a positive integer, N is an integer greater than 1, and the n slots are consecutive in time domain; and
selecting, by the terminal, a target resource for transmission or reservation from the second candidate resource set.

2. The method according to claim 1, wherein the selecting, by the terminal, the A second candidate resources from the first candidate resource set to form the second candidate resource set comprises:
reporting, by a second protocol layer of the terminal, the first candidate resource set to a first protocol layer; and
selecting, by the first protocol layer, the A second candidate resources from the first candidate resource set to form the second candidate resource set.

3. The method according to claim 2, wherein one first candidate resource occupies one slot or occupies i consecutive slots in time domain, and i is an integer greater than 1 and less than or equal to N.

4. The method according to claim 3, wherein one first candidate resource occupies i consecutive slots in time domain, the first protocol layer selects or preferentially selects a first candidate resource that meets a time-domain consecutiveness requirement as the second candidate resource, and the time-domain consecutiveness requirement comprises: the first candidate resource occupies M consecutive slots in time domain, or a combination of the first candidate resource and another first candidate resource occupies M consecutive slots in time domain, wherein M is an integer greater than or equal to i.

5. The method according to claim 3, wherein one first candidate resource occupies i consecutive slots in time domain, the consecutive i slots are comprised in a first time-domain consecutive resource, the first time-domain consecutive resource comprises M consecutive slot resources, and M is an integer greater than or equal to i.

6. The method according to claim 2, further comprising:
indicating, by the second protocol layer, a quantity of slots occupied by the target resource through Sidelink Control Information (SCI).

7. The method according to claim 2, wherein the reporting, by the second protocol layer, the first candidate resource set to the first protocol layer comprises:
determining at least one fourth candidate resource in a resource selection window, wherein one fourth candidate resource occupies n consecutive slots;
excluding a fifth resource from the at least one fourth candidate resource to obtain at least one sixth candidate resource, wherein the fifth resource comprises at least one of the following: an eighth resource, a ninth resource, or a resource comprising a physical sidelink feedback channel; and
determining the at least one sixth candidate resource as the first candidate resource set when the at least one sixth candidate resource satisfies a first condition; or adjusting a preset first Reference Signal Received Power (RSRP) threshold, and repeating the step of excluding the fifth resource from the fourth candidate resource, when the at least one sixth candidate resource does not satisfy a first condition, wherein
the first condition comprises at least one of the following:
in the first candidate resource set, a proportion of the sixth candidate resource in the fourth candidate resource is greater than or equal to a first preset value;
a ratio of a quantity of second time-domain consecutive resources in the first candidate resource set to a total quantity of resources in the resource selection window is greater than a second preset value; or
a quantity of second time-domain consecutive resources in the first candidate resource set is greater than a third preset value, wherein
the second time-domain consecutive resource comprises sixth candidate resources that are consecutive in time domain, or the second time-domain consecutive resource comprises sixth candidate resources that are consecutive and do not overlap in time domain;
the eighth resource satisfies the following condition: for a first slot in which SCI is not detected in a sensing window, all slots reserved for the first slot overlap with a slot reserved for the eighth resource in the resource selection window; and
the ninth resource satisfies the following condition:
for a slot in which first SCI is detected in the sensing window, all slots reserved in the resource selection window as indicated by the first SCI overlap with the ninth resource or a corresponding reserved resource, a reference value of RSRP of a target channel corresponding to the first SCI is greater than the first RSRP threshold, and the target channel is a Physical Sidelink Control Channel (PSCCH) or Physical Sidelink Shared Channel (PSSCH) for carrying the first SCI.

8. The method according to claim 7, wherein in the fourth candidate resource, each slot occupies a same frequency domain resource, or frequency domain resources in different slots are distributed based on a preset pattern, or
wherein the reference value of the RSRP is any one of the following:
an average value of RSRP of n slots of the ninth resource;
an equivalent value of RSRP of n slots of the ninth resource;
a maximum value of RSRP of n slots of the ninth resource;
a minimum value of RSRP of n slots of the ninth resource;
a preset partial value of RSRP of n slots of the ninth resource; or
RSRP of any one of n slots of the ninth resource.

9. The method according to claim 7, wherein the first RSRP threshold is determined by a priority of the PSSCH or a priority of the PSCCH indicated by SCI.

10. The method according to claim 7, wherein a time length of the fourth candidate resource is not greater than a length of channel occupancy time of the terminal, or
wherein a time domain position of the fourth candidate resource is determined by a candidate resource of a Physical Sidelink Feedback Channel (PSFCH).

11. The method according to claim 7, wherein determining the fourth candidate resource comprises:
determining a seventh candidate resource in the resource selection window, wherein the seventh candidate resource occupies one slot; and
selecting n seventh candidate resources that are consecutive in time domain to form one fourth candidate resource.

12. The method according to claim 7, further comprising:
receiving, by the first protocol layer, a resource evaluation detection result of a first resource reported by the second protocol layer; and
excluding the first resource from the second candidate resource set,
wherein the first resource belongs to a first set used for resource evaluation detection and satisfies at least one of the following: a resource corresponding to a first slot of the first resource does not overlap with a resource of any element in the first candidate resource set; or the first resource is not an element in the first candidate resource set.

13. The method according to claim 12, wherein a moment for triggering the second protocol layer to perform resource evaluation detection comprises at least one of the following:
a first moment, wherein the first moment is earlier than a seventh moment, duration between the first moment and the seventh moment is T3, and the seventh moment is a starting moment of a first slot of a fourth candidate resource with a smallest slot index;
a second moment, wherein the second moment is earlier than an eighth moment, duration between the second moment and the eighth moment is T3, and the eighth moment is a starting moment of a first slot of the second time-domain consecutive resource; or
a third moment, wherein the third moment is earlier than a ninth moment, duration between the third moment and the ninth moment is T3, and the ninth moment is a starting moment of a first slot of channel occupancy time, wherein
T3 is a preset value.

14. The method according to claim 13, wherein the moment for triggering the second protocol layer to perform the resource evaluation detection further comprises at least one of the following:
a fourth moment, wherein the fourth moment is earlier than a tenth moment, duration between the fourth moment and the tenth moment is T3, and the tenth moment is a starting moment of a slot of the fourth candidate resource other than the first slot of the fourth candidate resource;
a fifth moment, wherein the fifth moment is earlier than an eleventh moment, duration between the fifth moment and the eleventh moment is T3, and the eleventh moment is a starting moment of a slot of the second time-domain consecutive resource other than the first slot of the second time-domain consecutive resource; or
a sixth moment, wherein the sixth moment is earlier than a twelfth moment, duration between the sixth moment and the twelfth moment is T3, and the twelfth moment is a starting moment of a slot of the channel occupancy time other than the first slot of the channel occupancy time.

15. The method according to claim 14, wherein a third condition for the second protocol layer to report the resource evaluation detection result to the first protocol layer comprises at least one of the following:
for the resource evaluation detection triggered at the first moment, the second moment, or the third moment, RSRP of SCI corresponding to the first resource is greater than a preset second RSRP threshold; or
for the resource evaluation detection triggered at the fourth moment, the fifth moment, or the sixth moment, RSRP of SCI corresponding to the first resource is greater than a preset third RSRP threshold, and a preset offset exists between the third RSRP threshold and the second RSRP threshold.

16. The method according to claim 12, wherein after the second protocol layer performs the resource evaluation detection, the method further comprises:
skipping, by the terminal, resource reselection when a new candidate resource set does not comprise a candidate resource that is in a same slot as the excluded first resource; or
selecting or preferentially selecting, by the terminal, the candidate resource when a new candidate resource set comprises a candidate resource that is in a same slot as the excluded first resource.

17. The method according to claim 2, further comprising:
sending, by the second protocol layer when a second condition is satisfied, SCI to another terminal to indicate to release a reserved resource, wherein the second condition comprises at least one of the following:
a length of obtained channel occupancy time is less than a length of n slots;
a resource required for to-be-transmitted data of the terminal is less than n slots; or
a length of a slot for retransmission is less than a length of the n slots.

18. The method according to claim 2, wherein N is configured by an RRC layer, determined by the first protocol layer or, determined by the second protocol layer,
N configured by the RRC layer is determined based on at least one of the following:
a maximum number of retransmissions allowed;
a maximum quantity of slots for consecutive transmission;
a layer 1 priority of a transmission with the terminal;
a resource pool for the terminal;
a channel access priority class; or
a PC5 5th Generation (5G) Quality of Service (QOS) Indicator (PQI) of to-be-transmitted data of the terminal,
N determined by the first protocol layer is determined based on at least one of the following:
a higher-layer parameter indication;
information reported by the second protocol layer;
a length of channel occupancy time corresponding to a channel access priority class; or
a first candidate resource reported by the second protocol layer, and
N determined by the second protocol layer is determined based on at least one of the following:
a channel measurement result;
a length of channel occupancy time corresponding to a channel access priority class; or
a higher-layer parameter indication.

19. A terminal, comprising a processor and a memory storing instructions, wherein the instructions, when executed by the processor, cause the processor to perform operations comprising:
acquiring a first candidate resource set, wherein the first candidate resource set comprises at least one first candidate resource;
selecting A second candidate resources from the first candidate resource set to form a second candidate resource set, wherein one second candidate resource occupies n slots, n is an integer greater than or equal to 1 and less than or equal to N, A is a positive integer, N is an integer greater than 1, and the n slots are consecutive in time domain; and
selecting a target resource for transmission or reservation from the second candidate resource set.

20. A non-transitory computer readable storage medium storing instructions, that, when executed by a processor, cause the processor to perform operations comprising:
acquiring a first candidate resource set, wherein the first candidate resource set comprises at least one first candidate resource;
selecting A second candidate resources from the first candidate resource set to form a second candidate resource set, wherein one second candidate resource occupies n slots, n is an integer greater than or equal to 1 and less than or equal to N, A is a positive integer, N is an integer greater than 1, and the n slots are consecutive in time domain; and
selecting a target resource for transmission or reservation from the second candidate resource set.
